(19) United States
(12) Patent Application Publication
(10) Pub. No.: US 2012/0047354 A1
(43) Pub. Date: Feb. 23, 2012

(54) INFORMATION PROCESSING APPARATUS AND INFORMATION PROCESSING METHOD

(75) Inventors: Kenji Shimizu, Shizuoka (JP); Masanori Sambe, Shizuoka (JP)

(73) Assignee: TOSHIBA TEC KABUSHIKI KAISHA, Tokyo (JP)

(21) Appl. No.: 13/211,501

(22) Filed: Aug. 17, 2011

(30) Foreign Application Priority Data
Aug. 19, 2010 (JP) 2010-184044

(51) Int. Cl. G06F 9/302; G06F 9/305

(52) U.S. Cl. 712/221; 712/E09.017; 712/E09.018

(57) ABSTRACT

According to one embodiment, an information processing apparatus includes: a first verification section configured to perform true-false determination for a predetermined verification target using a verification item obtained by combining specified one of plural verification libraries respectively defining plural verification matters and an affirmative operator or a negative operator; a second verification section configured to subject, concerning the verification target, a true-false determination result of each of a plurality of the verification items verified by the first verification section to an arithmetic operation using a predetermined logical operator and obtain one arithmetic operation result; and an output section configured to output the arithmetic operation result of the second verification section.

### CROSS-REFERENCE TO RELATED APPLICATIONS

This application is based upon and claims the benefit of priority from the prior Japanese Patent Application No. 2010-184044, filed on Aug. 19, 2010; the entire contents of which are incorporated herein by reference.

### Filed

Embodiments described herein relate generally to an information processing apparatus and an information processing method.

### BACKGROUND

In the past, a verification target such as a data input value is verified using a predetermined verification condition to determine correctness of the data input value. In some case, plural verification conditions have to be combined to carry out verification of a verification target in a composite manner. Concerning this point, a standard framework in the past such as J2EE (Java2 Enterprise Edition; registered trademark) deals with only verification under a single verification condition. Therefore, one class obtained by integrating plural verification conditions is implemented to deal with verification under the plural verification conditions.

However, in the related art, if a verification target is verified using plural verification conditions in a composite manner, a class obtained by integrating the plural verification conditions needs to be implemented for each verification target. Therefore, it is likely that development cost and maintenance cost increase.

### DESCRIPTION OF THE DRAWINGS

FIG. 1 is a schematic block diagram of the configuration of an information processing apparatus according to an embodiment;

FIG. 2 is a diagram of a class configuration of the information processing apparatus shown in FIG. 1;

FIG. 3 is a flowchart for explaining an example of a procedure of data verification processing;

FIG. 4 is a diagram of an example of a verification target; and

FIG. 5 is a flowchart for explaining a procedure of data decision processing.

### DETAILED DESCRIPTION

In general, according to one embodiment, an information processing apparatus includes: a first verification section configured to perform true-false determination for a predetermined verification target using a verification item obtained by combining specified one of plural verification libraries respectively defining plural verification matters and an affirmative operator or a negative operator; a second verification section configured to subject, concerning the verification target, a true-false determination result of each of a plurality of the verification items verified by the first verification section to an arithmetic operation using a predetermined logical operator and obtain one arithmetic operation result; and an output section configured to output the arithmetic operation result of the second verification section.

In general, according to another embodiment, an information processing method includes: performing true-false determination for a predetermined verification target using a verification item obtained by combining specified one of plural verification libraries respectively defining plural verification matters and an affirmative operator or a negative operator; subjecting, concerning the verification target, a true-false determination result of each of a plurality of the verified verification items to an arithmetic operation using a predetermined logical operator and obtaining one arithmetic operation result; and outputting the arithmetic operation result.

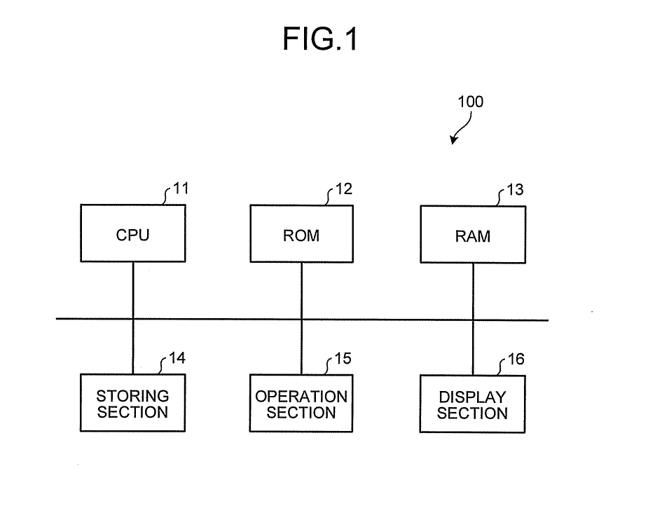

FIG. 1 is a schematic block diagram of the configuration of an information processing apparatus 100 according to an embodiment. As shown in the figure, the information processing apparatus 100 includes a CPU (Central Processing Unit) 11, a ROM (Read Only Memory) 12, a RAM (Random Access Memory) 13, a storing section 14, an operation section 15, and a display section 16.

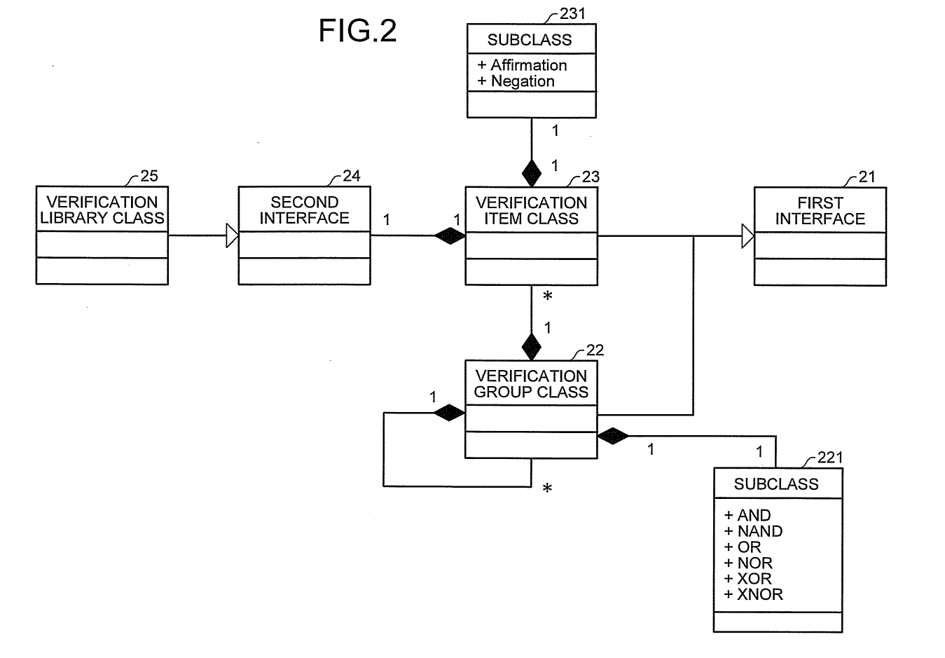

The CPU 11 expands predetermined computer programs, which are stored in the ROM 12 and the storing section 14, on the RAM 13 and executes the computer programs to collectively control operations of sections of the information processing apparatus 100. Specifically, the CPU 11 executes the predetermined computer program stored in the storing section 14 to realize a below-mentioned class configuration (see FIG. 2) for data verification. The CPU 11 reads out a below-mentioned verification conditional expression stored in the storing section 14 and inputs the verification conditional expression to the class configuration (see FIG. 2) together with predetermined data to be verified in the verification conditional expression (hereinafter referred to as verification target) to instruct execution of the verification conditional expression on the verification target.

The ROM 12 stores therein the predetermined computer program to be executed by the CPU 11 and setting information. The RAM 13 functions as a main storage device of the information processing apparatus 100 and is used as a work space of the CPU 11.

The storing section 14 is a storage device such as a HDD (Hard Disk Drive) and stores therein the predetermined computer program to be executed by the CPU 11 and various kinds of setting information related to the computer program. The storing section 14 stores therein the verification conditional expression representing a verification condition for a predetermined verification target.

The verification conditional expression used in this embodiment is an expression for instructing composite application of plural verification conditions. The verification conditional expression is formed in a tree structure as shown in the following Expression (1). The verification conditional expression (1) is an example of a verification conditional expression. Expression (1) requests a result same as a result of a logical arithmetic expression of Expression (2).

$$\begin{matrix}\begin{matrix}Group 1 ( AND ) \\ Item 1 ( Affirmation ) \\ Group 2 ( OR ) \\ Item 2 ( Negation ) \\ Item 3 ( Affirmation )\end{matrix} \} & ( 1 ) \\ Result = Item 1 AND \{ NOT ( Item 2 ) OR Item 3 \} & ( 2 )\end{matrix}$$

In the verification conditional expression (1), an expression (e.g., Item1(Affirmation)) represented by a set of “ItemN” (N is an integer) and an affirmative or negative operator (Affirmation (an affirmative operator) or Negation (a negative operator)) is a “verification item”. “ItemN” (N is an integer) is identification information for identifying verification items and used when a verification library is read out from a below-mentioned verification library class 25. This verification item defines that a verification result of a verification target by the verification library read out on the basis of the identification information is subjected to true-false determination using the affirmative or negative operator described in parentheses. A result obtained by subjecting the verification result of the verification library for the verification target using the affirmative or negative operator is hereinafter referred to as “true-false determination result of the verification item”.

The verification item is described in a “verification group” (e.g., Group1(AND)) represented by “GroupN” (N is an integer) and a logical operator (AND (logical product), NAND (negative logical product), OR (logical sum), NOR (negative logical sum), XOR (exclusive logical sum), XNOR (negation of exclusive logical sum), etc.).

The verification group is a group for deriving one verification result from true-false determination results of verification items. The verification group defines that true-false determination results of verification items included in the verification group are subjected to an arithmetic operation using a logical operator described in parentheses of the verification group. Other verification groups may be included in the verification group. In the verification conditional expression (1), “Group1(AND)” has a nesting structure in which “Group2(OR)” is included in “Group1(AND)”.

The verification conditional expression is stored in the storing section 14 in advance in association with input items and output items to and from which data to be verified is input and output.

The operation section 15 is an input device such as a keyboard or a mouse and outputs operation contents received from an operator of the information processing apparatus 100 to the CPU 11. The display section 16 is a display device such as an LCD (Liquid Crystal Display) and displays characters, an image, or the like according to control by the CPU 11.

A class configuration of the information processing apparatus 100 is explained below with reference to FIG. 2. FIG. 2 is a diagram of a class configuration related to data verification of the information processing apparatus 100. The class configuration is realized by cooperation of the CPU 11 and the predetermined computer program stored in the storing section 14.

As shown in FIG. 2, the class configuration of the information processing apparatus 100 includes a first interface 21, a verification group class 22, a verification item class 23, a second interface 24, and the verification library class 25. The class configuration shown in FIG. 2 is written using a unified modeling language UML, which is a unified notation of a program design drawing in object-oriented software development. A line represented by a white void arrow is a sign representing generalization in the UML. A line represented by a blackened diamond is a sign representing composition in the UML. Numerical values written at both ends of the line represented by the blackened diamond are multiplicity in the UML. An asterisk (*) means multiplicity and is an arbitrary number equal to or larger than 1.

The first interface 21 is an interface in the UML. The first interface 21 is a functional section equivalent to an input section and an output section and functions as an interface with the CPU 11. Specifically, when the first interface 21 receives an input of a verification conditional expression and a verification target from the CPU 11, the first interface 21 notifies the verification group class 22 of the verification conditional expression and the verification target. The first interface 21 outputs an arithmetic operation result of the verification conditional expression derived by the verification group class 22 to the CPU 11.

The verification group class 22 and the verification item class 23 are classes in the UML. The verification group class 22 and the verification item class 23 are in a relation of composition as shown in FIG. 2.

The verification group class 22 is a functional section equivalent to a second verification section. The verification group class 22 has logical operators (AND, NAND, OR, NOR, XOR, and XNOR) as a subclass 221. When the verification conditional expression and the verification target are notified from the first interface 21, the verification group class 22 instructs, on the basis of a tree structure forming the verification conditional expression, the verification item class 23 to perform true-false determination for a verification item with respect to the verification target and acquires a true-false determination result of the verification item from the verification item class 23. When the verification group class 22 acquires, concerning verification groups defined in the verification conditional expression, true-false determination results of all verification items included in the verification group, the verification group class 22 executes an arithmetic operation of the true-false determination result using a logical operator of the subclass 221 corresponding to a logical operator defined in the verification group and derives an arithmetic operation result.

The verification group class 22 recursively inputs the arithmetic operation result derived by the verification group class 22 to subject the derived arithmetic operation result and other true-false determination result or other arithmetic operation results to an arithmetic operation. When the verification group class 22 processes all verification items and verification groups defined in the verification conditional expression, the verification group class 22 returns a finally-derived arithmetic operation result to the first interface 21.

The verification item class 23 is a functional section equivalent to a first verification section. The verification item class 23 includes affirmative and negative operators (Affirmation and Negation) as a subclass 231. When verification of a verification item with respect to a verification target is instructed from the verification group class 22, the verification item class 23 notifies the second interface 24 of identification information of a verification library included in the verification item to acquire a verification library corresponding to the identification information from the verification library class 25 via the second interface 24.

The verification item class 23 combines the acquired verification library with an affirmative or negative operator of the verification item class 23 corresponding to an affirmative or negative operator included in the verification item to generate an instance (an entity) of the verification item. The verification item class 23 executes true-false determination for the verification target using the generated instance of the verification item and returns a result of the true-false determination to the group class 24 as a true-false determination result.

For example, if the verification item is a combination of a verification library defining “NULL” and Affirmation (the affirmative operator), the verification item class 23 determines “true” if a verification result of the verification library with respect to a predetermined verification target is NULL and determines “false” if the verification result is other than NULL. If the verification item is a combination of a verification library defining “NULL” and Negation (the negative operator), the verification item class 23 determines “false” if the verification target of the verification item with respect the predetermined verification target is NULL and determines “true” if the verification target is other than NULL.

The second interface 24 is an interface in the UML. The second interface 24 notifies the verification library class 25 of identification information of a verification library notified from the verification item class 23 to acquire the verification library corresponding to the identification information from the verification library class 25. The second interface 24 outputs the verification library acquired from the verification library class 25 to the verification item class 23.

The verification library class 25 is a functional section equivalent to a managing section and stores and manages plural verification libraries in which plural verification matters different from one another are respectively defined. In the verification libraries, for example, verification matters indicating that a verification target is “NULL”, “an integer”, and “within a predetermined numerical value range” are respectively defined. Identification information (e.g., a file name such as “Item1” shown in Expression 1) that can be uniquely identified is attached to each of the verification libraries. Contents defined in the verification libraries are not specifically limited and can be arbitrarily set according to a verification environment or verification content.

The verification library class 25 is a class library in the UML. When identification information is notified from the second interface 24, the verification library class 25 reads out a verification library corresponding to the identification information and provides the second interface 24 with the verification library.

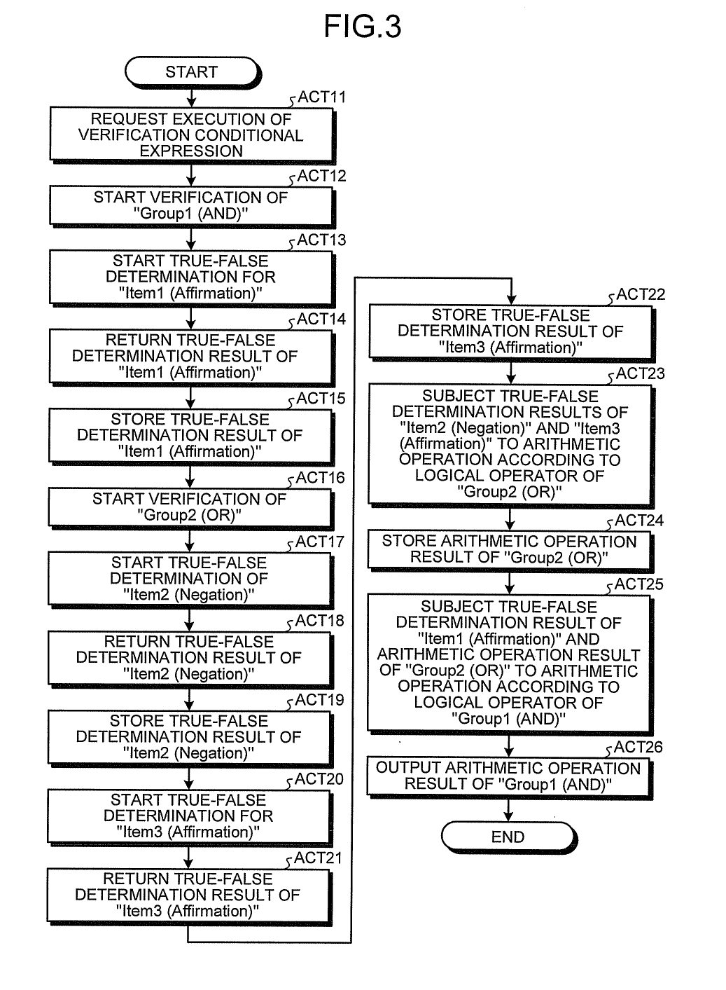

A procedure of data verification processing performed using the verification conditional expression (1) is explained with reference to FIG. 3. FIG. 3 is a flowchart for explaining an example of the procedure of the data verification processing.

When data to be verified is input to or output from a predetermined input item or output item, the CPU 11 reads out a verification conditional expression associated with the input item or output item from the storing section 14 and outputs the verification conditional expression to the first interface 21 together with the verification target to instruct the first interface 21 to execute the verification conditional expression on the verification target (ACT 11).

The first interface 21 receives an input of the verification conditional expression and the verification target. The first interface 21 notifies the verification group class 22 of contents of a verification group “Group1(AND)” described in a root of a tree structure forming the verification conditional expression and the verification target.

The verification group class 22 receives the notification of the verification group “Group1(AND)” and the verification target. The verification group class 22 starts verification of the verification group “Group1(AND)” with respect to the verification target (ACT 12).

Subsequently, the verification group class 22 analyzes the tree structure of the verification group “Group1(AND)” and extracts a verification item “Item1(Affirmation)” as a first element. The verification group class 22 instructs the verification item class 23 to execute true-false determination for the verification item “Item1(Affirmation)” with respect to the verification target.

The verification item class 23 acquires, according to the instruction from the verification group class 22, a verification library corresponding to identification information (Item1) included in the verification item “Item1(Affirmation)” from the verification library class 25 via the second interface 24. The verification item class 23 combines the verification library with “Affirmation” of the subclass 231 to generate an instance of the verification item. The verification item class 23 starts true-false determination for the verification target using the generated instance of the verification item (ACT 13) and returns a result of the true-false determination to the verification group class 22 (ACT 14). The verification group class 22 receives the true-false determination result concerning the verification item “Item1(Affirmation)” from the verification item class 23. The verification group class 22 stores the true-false determination result in the RAM 13 (ACT 15).

Subsequently, the verification group class 22 extracts a verification group “Group2(OR)”, which is the next element included in the verification group “Group1(AND)”. The verification group class 22 starts verification of the verification group “Group2(OR)” with respect to the verification target (ACT 16).

The verification group class 22 analyzes a tree structure of the verification group “Group2(OR)” and extracts a verification item “Item2(Negation)” as a first element. The verification group class 22 instructs the verification item class 23 to execute true-false determination for the verification item “Item2(Negation)” with respect to the verification target.

The verification item class 23 acquires, according to the instruction from the verification group class 22, a verification library corresponding to identification information (Item2) included in the verification item “Item2(Negation)” from the verification library class 25 via the second interface 24. The verification item class 23 combines the verification library with “Negation” of the subclass 231 to generate an instance of the verification item. The verification item class 23 starts true-false determination for the verification target using the generated instance of the verification item (ACT 17) and returns a result of the true-false determination to the verification group class 22 (ACT 18). The verification group class 22 receives the true-false determination result concerning the verification item “Item2(Negation)” from the verification item class 23. The verification group class 22 stores the true-false determination result in the RAM 13 (ACT 19).

Subsequently, the verification group class 22 extracts a verification items “Item3(Affirmation)”, which is the next element included in the verification group “Group2(OR)”. The verification group class 22 instructs the verification item class 23 to execute true-false determination for the verification item “Item3(Affirmation)” with respect to the verification target.

The verification item class 23 acquires, according to the instruction from the verification group class 22, a verification library corresponding to identification information (Item3) included in the verification item “Item3(Affirmation)” from the verification library class 25 via the second interface 24. The verification item class 23 combines the verification library with “Affirmation” of the subclass 231 to generate an instance of the verification item. The verification item class 23 starts true-false determination for the verification target using the generated instance of the verification item (ACT 20) and returns a result of the true-false determination to the verification group class 22 (ACT 21). The verification group class 22 receives the true-false determination result concerning the verification item “Item3 (Affirmation)” from the verification item class 23. The verification group class 22 stores the true-false determination result in the RAM 13 (ACT 22).

Subsequently, the verification group class 22 determines that all verification items included in the verification group “Group2(OR)” are processed. The verification group class 22 subjects a logical sum of the true-false determination results concerning the verification item “Item2(Negation)” and the verification item “Item3 (Affirmation)” stored in the RAM 13 to an arithmetic operation using a logical operator of the subclass 221 corresponding to a logical operator (OR) described in the verification group “Group2(OR)” (ACT 23). The verification group class 22 stores an arithmetic operation result of the verification group “Group2(OR)” derived in ACT 23 in the RAM 13 (ACT 24).

The verification group class 22 determines that the processing reaches the end of the verification conditional expression. The verification group class 22 returns to the root of the tree structure and subjects a logical product of the true-false determination result of the verification item “Item1(Affirmation)” and the arithmetic operation result of the verification group “Group2(OR)” stored in the RAM 13 to an arithmetic operation using a logical operator of the subclass 221 corresponding to a logical operator (AND) described in the verification group “Group1(AND)” (ACT 25). The verification group class 22 outputs an arithmetic operation result of the verification group “Group1(AND)” derived in ACT 25, i.e., an arithmetic operation result of the verification conditional expression to the CPU 11 via the first interface 21 (ACT 26).

In this way, in the class configuration of the information processing apparatus 100, an arithmetic operation of a true-false determination result for a verification item included in a verification group and/or a verification result of the verification group is performed using a logical operator defined in the verification group. Consequently, it is possible to easily execute composite verification conditions on a verification target. In the verification conditional expression, since a relation between verification groups and verification items is represented as a tree structure, it is possible to easily perform creation of composite verification conditions including a combination of plural verification conditions.

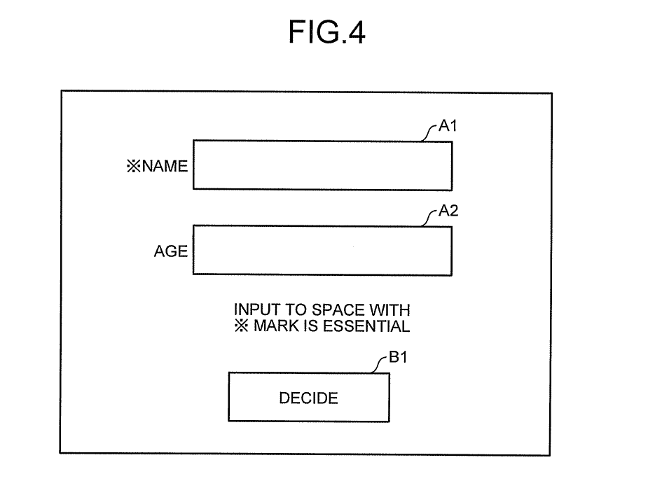

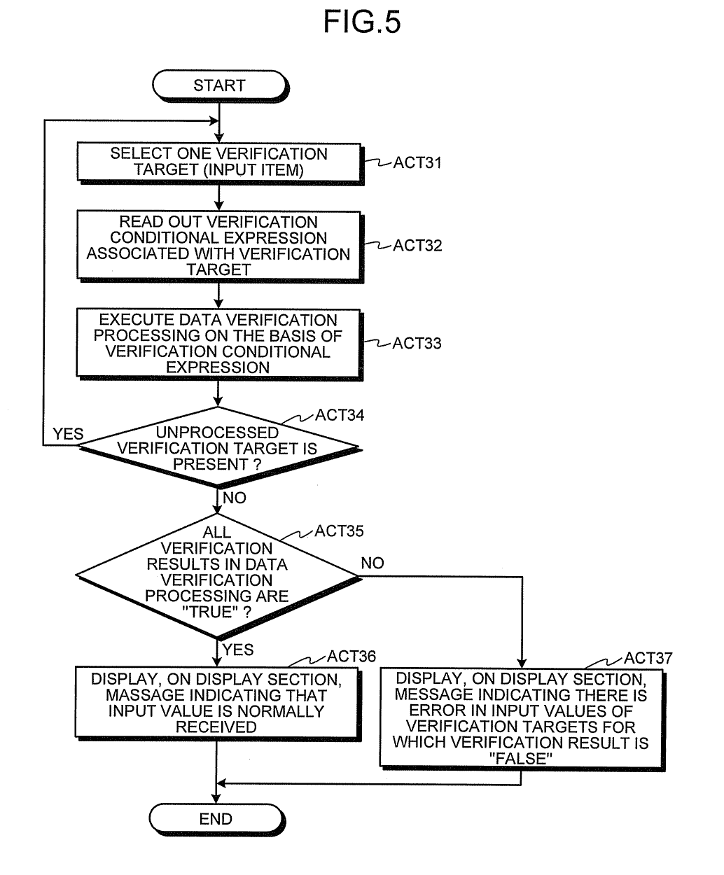

An example in which data input to a predetermined input item is set as a verification target is explained with reference to FIGS. 4 and 5.

FIG. 4 is a diagram of an example of the verification target by the class configuration explained above. A screen displayed on the display section 16 according to the control by the CPU 11 is shown. In the figure, an input item A1 is an area for inputting a name. A character string can be input to the input item A1 via the operation section 15. An input item A2 is an area for inputting an age. A character string can be input to the input item A2 via the operation section 15. A button B1 is a button for instructing decision of data input to the input item A1 and the input item A2. The input to the input item A1 is essential.

In FIG. 4, for example, in verification libraries corresponding to identification information Item11 to Item14 stored in the verification library class 25, verification matters described below are respectively defined.

Item11=a data input value is Null

Item12=a data input value is a numerical value

Item13=a data input value is a 2-byte character

Item14=a numerical value range of a data input value is 0 to 100

Further, a verification conditional expression (3) described below is stored in the storing section 14 in association with the input item A1. A verification conditional expression (4) described below is stored in the storing section 14 in association with the input item A2.

$$\begin{matrix}\begin{matrix}Group 11 ( AND ) \\ Item 11 ( Negation ) \\ Item 12 ( Negation ) \\ Item 13 ( Affirmation )\end{matrix} \} & ( 3 ) \\ \begin{matrix}Group 21 ( OR ) \\ Item 11 ( Affirmation ) \\ Group 22 ( AND ) \\ Item 12 ( Affirmation ) \\ Item 13 ( Negation ) \\ Item 14 ( Affirmation )\end{matrix} \} & ( 4 )\end{matrix}$$

When the CPU 11 receives pressing of the button B1 shown in FIG. 4, the CPU 11 executes data decision processing shown in FIG. 5 to execute data verification processing on data input values of the input items A1 and A2 according to the verification conditional expressions (3) and (4), respectively. The data decision processing is explained below with reference to FIG. 5.

First, the CPU 11 selects one of input items to which data of verification targets is input (ACT 31). If the input item A1 is selected, the CPU 11 reads out the verification conditional expression (3) associated with the input item A1 from the storing section 14 (ACT 32). Subsequently, the CPU 11 inputs the verification conditional expression (3) read out in ACT 32 to the first interface 21 together with a verification target (data) input to the input item A1 to instruct the class structure to execute execution of data verification processing for the verification target (ACT 33).

The verification group class 22 receives the verification conditional expression (3) and the verification target from the first interface 21. The verification group class 22 instructs the verification item class 23 to perform true-false determination by the verification items included in a verification group “Group11(AND)” and subjects a logical product of true-false determination results acquired from the verification item class 23 to an arithmetic operation to derive an arithmetic operation result of the verification conditional expression (3) with respect to the verification target. Specifically, concerning a verification item “Item11(Negation)”, the verification item class 23 determines “true” if data input to the input item A1 is not Null and determines “false” if the data is Null. Concerning a verification item “Item12(Negation)”, the verification item class 23 determines “true” if the data input to the input item A1 is not a numerical value and determines “false” if the data is a numerical value. Further, concerning a verification item “Item13(Affirmation)”, the verification item class 23 determines “true” if the data input to the input item A1 is a 2-byte character and determines “false” if the data is a 1-byte character.

Therefore, the verification group class 22 derives “false” as an arithmetic operation result of the verification group (Group11(AND)) if the data input to the input item A1 is Null, includes a numerical value, or includes a 1-byte character. The verification group class 22 derives “true” as an arithmetic operation result of the verification group (Group11(AND)) if the data input to the input item A1 is not Null, does not include a numerical value, or is a 2-byte character. In other words, an arithmetic operation result is “true” only if a character string of 2-byte characters other than a number is input to the input item A1.

The CPU 11 determines, according to the input of the arithmetic operation result from the first interface 21, that the data verification processing in ACT 33 is completed. The CPU 11 determines whether an unprocessed verification target is present (ACT 34). If the CPU 11 determines that an unprocessed verification target is present (Yes in ACT 34), the CPU 11 returns to ACT 31 and selects an input item to which the unprocessed verification target is input (ACT 31).

If the input item A2 is selected, the CPU 11 reads out the verification conditional expression (4) associated with the input item A2 from the storing section 14 (ACT 32). Subsequently, the CPU 11 inputs the verification conditional expression (4) read out in ACT 32 to the first interface 21 together with a verification target (data) input to the input item A2 to instruct the class structure to execute data verification processing for the verification target (ACT 33).

The verification group class 22 receives the verification conditional expression (4) and the verification target from the first interface 21. The verification group class 22 instructs the verification item class 23 to perform true-false determination by verification items included in a verification group “Group21(OR)” and subjects a logical sum of true-false determination results acquired from the verification item class 23 to an arithmetic operation to derive an arithmetic operation result of the verification conditional expression (4) with respect to the verification target.

Specifically, concerning a verification item “Item11(Affirmation)”, the verification item class 23 determines “true” if data input to the input item A2 is Null and determines “false” if the data is not Null. Concerning a verification item “Item12(Affirmation)” included in a verification group “Group22(AND)”, the verification item class 23 determines “true” if the data input to the input item A2 is a numerical value and determines “false” if the data is not a numerical value. Further, concerning a verification item “Item13(Negation)”, the verification item class 23 determines “true” if the data input to the input item A2 is a 1-byte character and determines “false” if the data is a 2-byte character. Further, concerning a verification item “Item14(Affirmation)”, the verification item class 23 determines “true” if the data input to the input item A2 is included in a numerical value range of 0 to 100 and determines “false” if the data deviates from the numerical value range of 0 to 100.

The verification group class 22 derives, on the basis of the verification result obtained from the verification item class 23 concerning the verification group (Group22(AND)), “false” as an arithmetic operation result of the verification group (Group22(AND)) if the data input to the input item A2 includes a character string other than a numerical value, is a 2-byte character, or deviates from the numerical value range of 0 to 100. Concerning the verification group “Group22(AND)”, the verification group class 22 derives “true” as an arithmetic operation result of the verification group “Group22(AND)” if the data input to the input item A2 is a numerical value, is a 1-byte character, and is included in the numerical value range of 0 to 100.

Concerning the verification group “Group21(OR)” as the root of the tree structure, the verification group class 22 derives “true” if a set of arithmetic operation results of the verification item “Item11(Affirmation)” and the verification group “Group22(AND)” is “true-true”, “true-false”, or “false-true” and derives “false” if the set is “false-false”. In other words, the verification group class 22 derives “true” only if an input value to the input item A2 is a blank (Null) or a numerical value in the numerical value range of 0 to 100.

The CPU 11 determines, according to the input of the arithmetic operation result from the first interface 21, that the data verification processing in ACT 33 is completed. In ACT 34, the CPU 11 determines whether an unprocessed verification target is present. If the CPU 11 determines that an unprocessed verification target is not present (No in ACT 34), the CPU 11 shifts to ACT 35.

In ACT 35, the CPU 11 determines whether all arithmetic operation results of the data verification processing in ACT 33 are “true” (ACT 35). If the CPU 11 determines that all the arithmetic operation results are “true” (Yes in ACT 35), the CPU 11 displays, on the display section 16, a message indicating that data input values of the input items A1 and A2 are normally received (ACT 36) and ends the processing. If the CPU 11 determines that some arithmetic operation results are “false” (No in ACT 35), the CPU 11 displays, on the display section 16, a message indicating that there is an error in data input values of input items for which the arithmetic operation results are “false” (ACT 37) and ends the processing.

In the processing shown in FIG. 5, the processing is put forward assuming that a normal operation is performed if a final arithmetic operation result is “true”. However, the processing may be put forward assuming that a normal operation is performed if a final arithmetic operation result is “false”.

As explained above, with the information processing apparatus 100, verification conditions (verification items) for plural verification targets are generated using a common verification library. True-false determination results of the verification items are subjected to an arithmetic operation using the logical operators of the verification group class 22. Consequently, composite verification with combined verification conditions can be efficiently performed. Therefore, it is possible to reduce loads related to development cost and maintenance cost.

The embodiment is explained above. However, the present invention is not limited to the embodiment. Various modifications, replacements, additions, and the like are possible without departing from the spirit of the present invention.

For example, in the embodiment, data input values input to the predetermined input items are verification targets. However, verification targets are not limited to this example.

In the embodiment, the computer program executed in the information processing apparatus 100 is provided while being incorporated in the storing section 14 in advance. However, a form of provision of the computer program is not limited to this. The computer program may be provided while being recorded in a computer-readable recording medium such as a CD-ROM, a flexible disk (FD), a CD-R, or a DVD (Digital Versatile Disc) as a file of an installable format or an executable format. The recording medium is not limited to a medium independent from a computer or an incorporated system and includes a recording medium in which the computer program transmitted by a LAN, the Internet, or the like is downloaded and stored or temporarily stored.

The computer program executed in the information processing apparatus 100 may be stored on a computer connected to a network such as the Internet and provided by being downloaded through the network or may be provided or distributed through the network such as the Internet.

What is claimed is:

1. An information processing apparatus comprising:
a first verification section configured to perform true-false determination for a predetermined verification target using a verification item obtained by combining specified one of plural verification libraries respectively defining plural verification matters and an affirmative operator or a negative operator;
a second verification section configured to subject, concerning the verification target, a true-false determination result of each of a plurality of the verification items verified by the first verification section to an arithmetic operation using a predetermined logical operator and obtain one arithmetic operation result; and
an output section configured to output the arithmetic operation result of the second verification section.

2. The apparatus according to claim 1, further comprising an input section configured to receive input of a verification conditional expression describing a verification group for defining a set of the verification library included in each of the verification items and the affirmative operator or the negative operator and defining the logical operator used for the arithmetic operation of the true-false determination result in the verification item, wherein
the first verification section performs the true-false determination for the verification target using each of the plural verification items including sets of the verification libraries and the affirmative operator or the negative operator defined in the verification group, and
the second verification section subjects the true-false determination result of each of the plural verification items verified by the first verification section to the arithmetic operation using the logical operator described in the verification group.

3. The apparatus according to claim 2, wherein the second verification section performs, if the verification group described in the verification conditional expression includes another verification group, an arithmetic operation of the verification group recursively using an arithmetic operation result in the other verification group.

4. The apparatus according to claim 1, wherein each of the first verification section and the second verification section is a class, and the first verification section is in a relation of composition with the second verification section.

5. The apparatus according to claim 1, further comprising a managing section configured to store and mange the plural verification libraries, wherein
the first verification section generates an instance of the verification item using the specified verification library acquired from the managing section and performs the true-false determination for the predetermined verification target.

6. The apparatus according to claim 5, wherein
the verification item includes unique identification information, and
the first verification section acquires, on the basis of the identification information included in the verification item, from the managing section, the one verification library specified from the plural verification libraries.

7. The apparatus according to claim 4, wherein
the first verification section has a subclass including the affirmative operator and the negative operator included in the verification item, and
the second verification section has a subclass including the logical operator included in a verification group.

8. The apparatus according to claim 2, further comprising a storing section configured to store the verification conditional expression in association with a predetermined input and output item to which data of a verification target is input or from which the data is output.

9. The apparatus according to claim 8, further comprising a control section configured to read out, when the data of the verification target is input to or output from the input and output item, the verification conditional expression associated with the item from the storing section, inputs the verification conditional expression to the input section, and starts verification of the data.

10. The apparatus according to claim 9, wherein the control section determines correctness of the data of the verification target according to the arithmetic operation result output by the output section.

11. The apparatus according to claim 2, wherein the verification conditional expression is described in a tree structure.

12. An information processing method comprising:
performing true-false determination for a predetermined verification target using a verification item obtained by combining specified one of plural verification libraries respectively defining plural verification matters and an affirmative operator or a negative operator;
subjecting, concerning the verification target, a true-false determination result of each of a plurality of the verified verification items to an arithmetic operation using a predetermined logical operator and obtaining one arithmetic operation result; and
outputting the arithmetic operation result.
